(19) United States
(12) Patent Application Publication
(10) Pub. No.: US 2019/0051275 A1
(43) Pub. Date: Feb. 14, 2019

(54) METHOD FOR PROVIDING ACCOMPANIMENT BASED ON USER HUMMING MELODY AND APPARATUS FOR THE SAME

(71) Applicant: COOLJAMM Company, Seoul (KR)

(72) Inventors: Keehwan KA, Yongin-si (KR); Young Ki AHN, Yongin-si (KR); Ji Eun PARK, Seoul (KR); Byungik Choi, Seoul (KR)

(73) Assignee: COOLJAMM Company, Seoul (KR)

(21) Appl. No.: 15/809,118

(22) Filed: Nov. 10, 2017

(30) Foreign Application Priority Data
Aug. 10, 2017 (KR) 10-2017-0101791

(51) Int. Cl. G10H 1/36; G10H 5/00; G06F 17/30

(52) U.S. Cl. CPC G10H 1/366; G10H 5/005; G10H 2210/571; G10H 2210/076; G10H 2210/066; G06F 17/30758

(57) ABSTRACT

Provided is an apparatus for providing an accompaniment based on a humming melody. The apparatus includes a user input receiver configured to receive a humming melody of a user, a melody extractor configured to measure a pitch from the received humming melody, a key extractor configured to extract a key from the humming melody, and a chord generator configured to generate a chord for each measure based on the humming melody.

### CROSS-REFERENCE TO RELATED APPLICATION(S)

This application claims the priority benefit of Korean Patent Application No. 10-2017-0101791 filed on Aug. 10, 2017 in the Korean Intellectual Property Office, the disclosure of which is incorporated herein by reference for all purposes.

### BACKGROUND

### 1. Field

One or more example embodiments relate to a method of providing an appropriate accompaniment based on a humming melody of a user and an apparatus for the method, and more particularly, to a method of automatically generating suitable accompaniment and music score information based on a humming melody input through a user device and providing a user with the same and an apparatus for the method.

### 2. Description of Related Art

It may not be easy for non-musicians or amateur musicians to compose music. That is because in general they may not read a score or play a musical instrument such as the piano or the violin, or may lack related expert knowledge. However, an ordinary person who likes music may sing with humming, and often hum a song of his or her favorite singer, a portion of famous classical music, or music that he or she instantly creates. It is not difficult to create and hum his or her own music or melody. However, it may be extremely difficult and take a long time for an amateur musician to compose music based on a humming melody.

Composition of music is difficult because first it is difficult to read a score, second it is difficult to appropriately write musical notes corresponding to sounds that come into mind, and third it is not easy for an amateur musician to have knowledge related to related instruments or play related instruments although he or she needs to do the same to transfer a melody into scores of various instruments. Thus, if there is no need to read a score, directly write musical notes, or discern accurate sounds and rhythms by playing a musical instrument, a desire and a demand of an ordinary person to compose music may be much greater.

Accordingly, a service that may enable an ordinary person not having expert knowledge to easily compose natural music by automatically providing a score and an accompaniment suitable for a humming melody simply provided by a user is needed.

### SUMMARY

An aspect provides a method and apparatus that may enable an ordinary person not having expert knowledge to easily compose natural music by automatically providing a score and an accompaniment suitable for a humming melody of a user based on the humming melody.

Another aspect also provides a method and apparatus for providing an accompaniment based on a humming melody of a user that additionally has a melody correcting function in view of a unique characteristic of each user, a natural melody line, and a chord based on a melody input through a user voice or humming with inaccurate pitches unlike a musical instrument performance.

Still another aspect also provides a method and apparatus for providing an accompaniment based on a humming melody of a user that may calculate a representative corrected tempo (beat per minute (BPM)) in view of an overall flow when a tempo is not uniform in a whole section in a case in which a melody is input through a user voice or humming.

Yet another aspect also provides a method and apparatus for providing an accompaniment and a score that are suitable for an intent of a user and more natural by supplementing an inaccurate melody input through a humming of the user and adding a musicality (musical rules).

The technical tasks obtainable from the present disclosure are non-limited by the above-mentioned technical tasks. And, other unmentioned technical tasks can be clearly understood from the following description by those having ordinary skill in the technical field to which the present disclosure pertains.

According to an aspect, there is provided an apparatus for providing an accompaniment based on a humming melody, the apparatus including a user input receiver configured to receive a humming melody of a user, a melody extractor configured to measure a pitch from the received humming melody, a key extractor configured to extract a key from the humming melody, and a chord generator configured to generate a chord for each measure for the accompaniment based on the humming melody.

The apparatus may further include a bias corrector configured to correct the pitch of the received humming melody. The apparatus may further include a tempo (BPM) corrector configured to correct and calculate a tempo in a whole section or a portion of the section based on tempo values measured in a plurality of partial sections.

Here, the tempo (BPM) corrector may include a local BPM measurer configured to measure BPMs in a plurality of predetermined window sections and a representative tempo (BPM) calculator configured to calculate an overall or section tempo (BPM) based on a plurality of local tempo (BPM) values measured by the local tempo measurer, and at least a portion of the plurality of predetermined window sections may overlap at least one of an immediately previous window section and an immediately subsequent window section. The tempo (BPM) corrector may be configured to calculate, as a representative tempo (BPM) value, one of a mean value, a median value, and a mode value of tempo (BPM) values in the plurality of predetermined window sections.

The bias corrector may include a difference sound corrector configured to correct a difference sound from a reference sound. The difference sound corrector may be configured to correct the difference sound based on difference sound information of the user that is verified previously. The difference sound corrector may be configured to correct the difference sound by measuring a degree and a direction of a difference in comparison to the reference sound. The chord generator may be configured to generate the chord based on constituent sounds of the corresponding measure and a chord composition of a previous measure.

The apparatus may further include an accompaniment corrector configured to correct a melody based on at least one of information related to the key extracted by the key extractor and information related to the chord generated by the chord generator.

The apparatus may further include a melody similarity determiner configured to determine similarities between a melody extracted by the melody extractor and a plurality of melodies stored in a melody database (DB), and a melody similarity based corrector configured to correct at least a portion of the extracted melody based on a similarity between the extracted melody and a predetermined melody among the plurality of melodies stored in the melody DB in response to determination that the extracted melody is similar to the predetermined melody. Here, the melody similarity based corrector may be configured to correct the melody by applying at least one of a genre, an era, a country, a region, and a music style for each musician.

According to another aspect, there is also provided a method of providing an accompaniment based on a humming melody, the method including a user input operation of receiving a humming melody of a user, a melody extracting operation of measuring a pitch from the received humming melody, a key extracting operation of extracting a key from the humming melody, and a chord generating operation of generating a chord for each measure for the accompaniment based on the humming melody.

The method may further include a bias correcting operation of correcting the pitch of the received humming melody. The method may further include a tempo (BPM) correcting operation of correcting and calculating a tempo in a whole section or a portion of the section based on tempo values measured in a plurality of partial sections.

Here, the tempo (BPM) correcting operation may include a local BPM measuring operation of measuring BPMs in a plurality of predetermined window sections and a representative tempo (BPM) calculating operation of calculating a representative tempo (BPM) based on a plurality of local tempo (BPM) values obtained in the local BPM measuring operation, and at least a portion of the plurality of predetermined window sections may overlap at least one of an immediately previous window section and an immediately subsequent window section. The tempo (BPM) correcting operation may be configured to calculate, as a representative tempo (BPM) value, one of a mean value, a median value, and a mode value of tempo (BPM) values in the plurality of predetermined window sections.

The bias correcting operation may include a difference sound correcting operation of correcting a difference sound from a reference sound. The difference sound correcting operation may be configured to correct the difference sound based on difference sound information of the user that is verified previously. The difference sound correcting operation may be configured to correct the difference sound by measuring a degree and a direction of a difference in comparison to the reference sound. The chord generating operation may be configured to generate the chord based on constituent sounds of the corresponding measure and a chord composition of a previous measure.

The method may further include an operation of correcting a melody based on at least one of information related to the key extracted in the key extracting operation and information related to the chord generated in the chord generating operation.

The method may further include a melody similarity determining operation of determining similarities between a melody extracted in the melody extracting operation and a plurality of melodies stored in a melody DB, and a melody similarity based correcting operation of correcting at least a portion of the extracted melody based on a similarity between the extracted melody and a predetermined melody among the plurality of melodies stored in the melody DB in response to determination that the extracted melody is similar to the predetermined melody. Here, the melody similarity based correcting operation may be configured to correct the melody by applying at least one of a genre, an era, a country, a region, and a music style for each musician.

Additional aspects of example embodiments will be set forth in part in the description which follows and, in part, will be apparent from the description, or may be learned by practice of the disclosure.

### Effects

According to an example embodiment, a method and apparatus that may enable an ordinary person not having expert knowledge to easily compose natural music by automatically providing a score and an accompaniment suitable for a humming melody of a user based on the humming melody may be provided.

According to an example embodiment, a method and apparatus for providing an accompaniment based on a humming melody of a user that additionally has a melody correcting function in view of a unique characteristic of each user, a natural melody line, and a chord based on a melody input through a user voice or humming with inaccurate pitches unlike a musical instrument performance may be provided.

According to an example embodiment, a method and apparatus for providing an accompaniment based on a humming melody of a user that may calculate a representative corrected tempo (BPM) in view of an overall flow when a tempo is not uniform in a whole section in a case in which a melody is input through a user voice or humming may be provided.

According to an example embodiment, a method and apparatus for providing an accompaniment and a score that are suitable for an intent of a user and more natural by supplementing an inaccurate melody input through a humming of the user and adding a musicality (musical rules) may be provided.

The effects obtainable from the present disclosure are non-limited by the above-mentioned effects. And, other unmentioned effects can be clearly understood from the following description by those having ordinary skill in the technical field to which the present disclosure pertains.

### BRIEF DESCRIPTION OF THE DRAWINGS

These and/or other aspects, features, and advantages of the disclosure will become apparent and more readily appreciated from the following description of example embodiments, taken in conjunction with the accompanying drawings of which:

FIG. 1 illustrates an example of a method and apparatus for providing an accompaniment based on a humming melody of a user according to an example embodiment;

FIG. 2 is a block diagram illustrating a configuration of an apparatus for providing an accompaniment based on a humming melody of a user according to an example embodiment;

FIG. 3 is a flowchart illustrating a method of providing an accompaniment based on a humming melody of a user according to an example embodiment;

FIG. 4 is a flowchart illustrating a method of providing an accompaniment based on a humming melody of a user according to another example embodiment;

FIG. 5 is a block diagram illustrating a configuration of a tempo (beat per minute (BPM)) corrector of an apparatus for providing an accompaniment based on a humming melody of a user according to an example embodiment;

FIG. 6 illustrates an example of a tempo (BPM) correcting operation according to an example embodiment;

FIG. 7 illustrates an example of a score with an indication of an overall tempo (BPM) according to an example embodiment; and

FIG. 8 is a flowchart illustrating an operation of correcting a melody based on similarities to pre-stored melodies according to an example embodiment.

### DETAILED DESCRIPTION

Hereinafter, some example embodiments will be described in detail with reference to the accompanying drawings. Regarding the reference numerals assigned to the elements in the drawings, it should be noted that the same elements will be designated by the same reference numerals, wherever possible, even though they are shown in different drawings. In drawings, parts irrelevant to the description are omitted for the simplicity of explanation, and like reference numerals denote like parts through the whole document.

The terminology used herein is for the purpose of describing particular example embodiments only and is not intended to be limiting. As used herein, the singular forms “a,” “an,” and “the,” are intended to include the plural forms as well, unless the context clearly indicates otherwise.

It will be further understood that the terms “comprises,” “comprising,” “includes,” and/or “including,” when used herein, specify the presence of stated features, integers, steps, operations, elements, and/or components, but do not preclude the presence or addition of one or more other features, integers, steps, operations, elements, components, and/or groups thereof.

In addition, terms such as first, second, A, B, (a), (b), and the like may be used herein to describe components. Each of these terminologies is not used to define an essence, order or sequence of a corresponding component but used merely to distinguish the corresponding component from other component(s). Also, in the description of example embodiments, detailed description of well-known related structures or functions will be omitted when it is deemed that such description will cause ambiguous interpretation of the present disclosure.

Furthermore, constituent units included in example embodiments of the present disclosure are independently illustrated to describe different specific functions, and each of the constituent units may not indicate separate hardware or one software element. That is, the respective constituent units are arranged and included for convenience of description. Among the constituent units, two or more constituent units may be combined to serve as one constituent unit, and one constituent unit may be divided into a plurality of constituent units to perform a function. The integrated example embodiment of the constituent units and the divided example embodiments of each constituent unit are included in the claims as long as they do not depart from the spirit of the present disclosure.

Hereinafter, example embodiments will be described in detail with reference to the accompanying drawings. The configuration and effects thereof can be clearly understood from the following description.

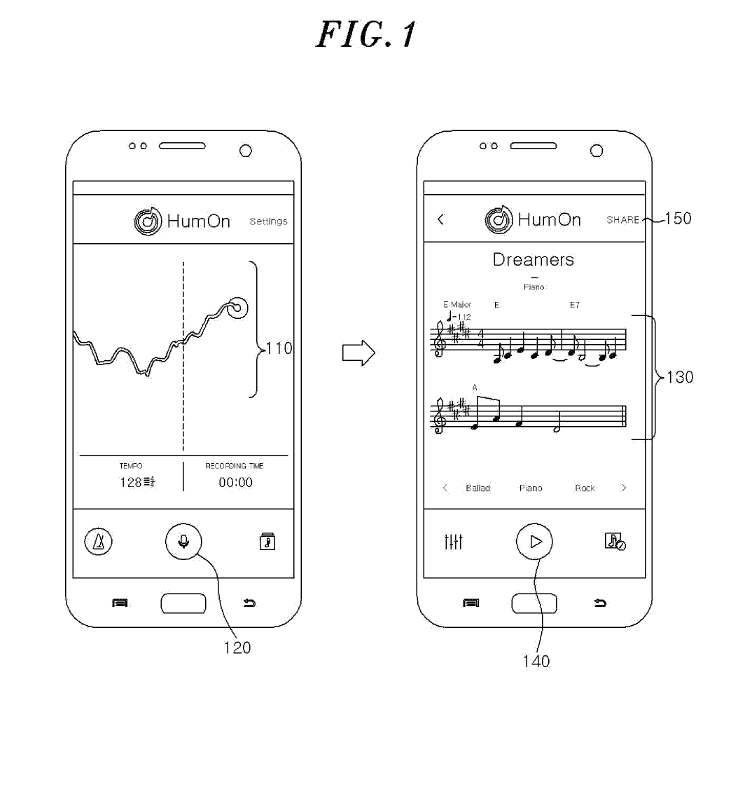

FIG. 1 illustrates an example of a method and apparatus for providing an accompaniment based on a humming melody of a user according to an example embodiment.

A left image of FIG. 1 illustrates a display of a user device that receives a melody being input through a user voice or humming. A user may start a humming or voice input by touching a record button 120, and changes in pitches may be displayed in real time on a main screen 110 based on the melody input from the user. Further, a tempo of the melody may be displayed using a beat per minute (BPM) value on the display of the user device, and a recording time may be displayed together.

When the input of the user melody is terminated, the user device may analyze and correct the melody and convert the melody into a score, automatically generate an accompaniment of chords harmonizing therewith, and display a completed score on a main screen 130. Further, a music genre may be displayed and selected through the display of the user device, and the user may start a play of the completed score by touching a music play button 140.

Further, the user may share the composed score easily with other media of the user or other people through a share button 150 displayed on the user display, for example, send an email, post on a blog, post on a social network service (SNS), store in a memo pad, or share with friends.

Hereinafter, an apparatus and method for providing an accompaniment based on a humming melody of a user that may generate an accompaniment and a score that are suitable for an intent of the user and most natural to provide an accompaniment based on a melody such as a humming input by the user will be described further.

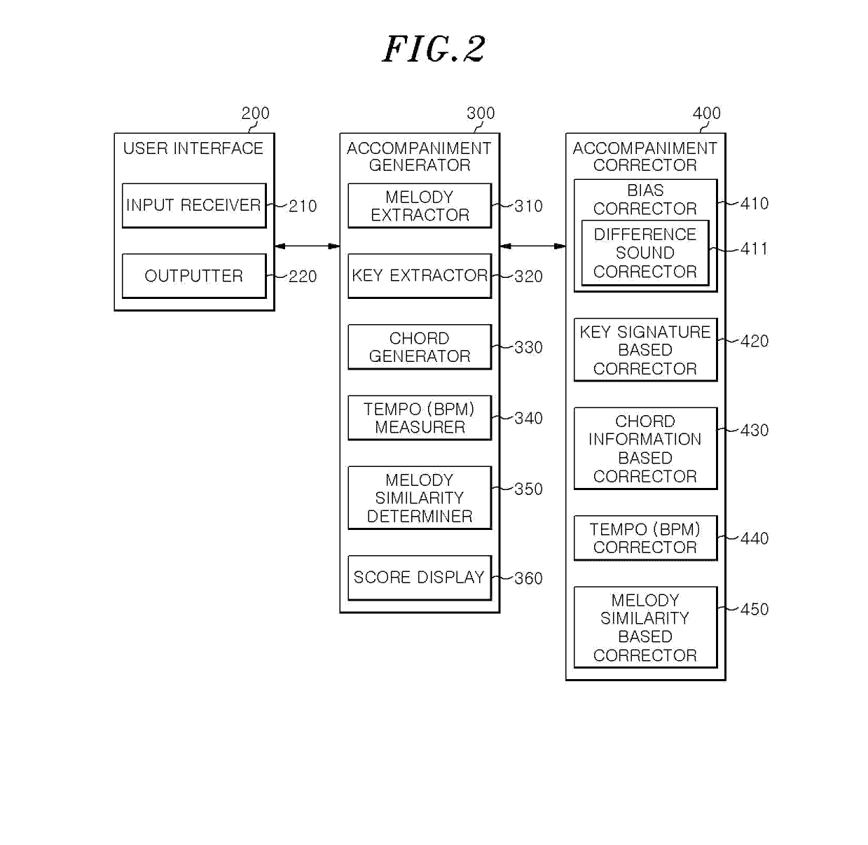

FIG. 2 is a block diagram illustrating a configuration of an apparatus for providing an accompaniment based on a humming melody of a user according to an example embodiment.

First, the apparatus for providing an accompaniment based on a humming melody of a user may be a terminal configured to receive, process, and display various data via wired and wireless communication networks in response to input and output controls of the user, and may be, for example, one of a smart phone, a tablet computer, a desktop computer, a laptop computer, a notebook computer, a workstation, a personal digital assistant (PDA), a portable computer, a wireless phone, a mobile phone, an e-book, a portable multimedia player (PMP), a portable game console, a navigation system, a black box, a digital camera, a television, a wearable device, a voice recognition speaker, a smart speaker, and an artificial intelligence (AI) speaker. However, the example embodiments are not limited thereto.

Referring to FIG. 2, the apparatus for providing an accompaniment based on a humming melody of a user may include a user interface 200, an accompaniment generator 300, and an accompaniment corrector 400.

The user interface 200 may include, as constituent elements configured to perform an input and an output from and to a user, an input receiver 210 configured to receive various inputs from the user using various methods, and an outputter 220 configured to perform various outputs using various methods. Further, the input receiver 210 and the outputter 220 may be configured as separate constituent elements, or may be configured as a single integrated constituent element.

The input receiver 210 may include a microphone configured to receive an input of a voice or a humming melody of the user, and may include an inputter including at least one of a touch pad, a touch panel, a key pad, a dome switch, a physical button, a jog shuttle, and a sensor to receive various inputs for control and selection of the user. However, the example embodiments are not limited thereto.

The outputter 220 may include a speaker configured to output a play of an accompaniment generated based on the humming melody of the user, and a display configured to visually provide the user with a score of the accompaniment and a variety of related information. Here, the display may include, for example, a liquid crystal display (LCD), a light emitting diode (LED) display, an organic LED (OLED) display, a micro LED, a micro electro mechanical system (MEMS) display, and an electronic paper display. However, the example embodiments are not limited thereto. Further, the display may be implemented in a form of a touch screen by being combined with the input receiver 210.

The accompaniment generator 300 and the accompaniment corrector 400 may be configured in a controller of the apparatus for providing an accompaniment based on a humming melody of a user, and may perform data processing or operations related to communication and control of one or more other constituent elements. For example, the controller in which the accompaniment generator 300 and the accompaniment corrector 400 are disposed may include one or more processors (e.g., a central processing unit (CPU) and an application processor (AP)), and may include a memory configured to store data or instructions related to one or more other constituent elements or may communicate with an external memory. The accompaniment generator 300 and the accompaniment corrector 400 may include program modules that may be executed by the one or more processors. The program modules included in the accompaniment generator 300 may be in the form of operating systems, application program modules, or other program modules, while they may be physically stored on a variety of commonly known storage devices. Such program modules may include, but not limited to, routines, subroutines, programs, objects, components, instructions, data structures, and the like for performing specific tasks or executing specific abstract data types as will be described below in accordance with the present disclosure.

The accompaniment generator 300 may generate an accompaniment based on the humming melody of the user received through the input receiver 210, and may generate a final accompaniment by reflecting an accompaniment correction performed by the accompaniment corrector 400 to generate an accompaniment and a score that are suitable for an intent of the user and most natural and express the same as a score.

The accompaniment generator 300 may include a melody extractor 310, a key extractor 320, a chord generator 330, a tempo (BPM) measurer 340, a melody similarity determiner 350, and a score display 360. The melody extractor 310, the key extractor 320, the chord generator 330, the tempo (BPM) measurer 340, the melody similarity determiner 350, and the score display 360 may be in the form of, for example, routines, subroutines, programs, objects, components, instructions, data structures, and the like for performing specific tasks or executing specific abstract data types as will be described below in accordance with the present disclosure.

The melody extractor 310 of the accompaniment generator 300 may be configured to measure a pitch from the humming melody of the user received through the input receiver 210. The melody extractor 310 may measure the pitch of the humming melody of the user in real time, and display the measured pitch in real time through the outputter 220 such that the user may verify a change in the pitch in real time.

The accompaniment corrector 400 may include a bias corrector 410, a key signature based corrector 420, a chord information based corrector 430, a tempo (BPM) corrector 440, and a melody similarity based corrector 450. The bias corrector 410, the key signature based corrector 420, the chord information based corrector 430, the tempo (BPM) corrector 440, and the melody similarity based corrector 450 may be in the form of, for example, routines, subroutines, programs, objects, components, instructions, data structures, and the like for performing specific tasks or executing specific abstract data types as will be described below in accordance with the present disclosure.

A bias corrector 410 of the accompaniment corrector 400 may be configured to wholly or partially correct a shaking of a melody line or a pitch of a melody prejudiced or biased in one direction from the received melody.

Each user has a unique sense of pitch and a unique style, and thus the bias corrector 410 may discern and correct a bias due to an individual difference that may appear at a beginning or an end of music or in whole music. For example, some users may sing each note of a corresponding scale wholly consistently with a slightly high pitch or with a slightly low pitch. In this example, an overall pitch correction may be performed. Further, in a case of mismatching with a pitch of each note of the corresponding scale due to an unstable humming in a portion of a section rather than the whole section, a pitch correction may be performed with respect to the portion of the section. The bias corrector 410 may discern a bias tendency of each user by storing and managing information related to a bias correction for each user, and perform a user customized melody pitch correction by discerning an intent of the user more accurately based on past data accumulated as described above. Thus, as a user iteratively generates accompaniments with a predetermined pattern, a bias pattern of the user may be discerned more accurately, and thus a bias correction suitable for an intent of the user may be performed more accurately.

Further, to correct a bias from a reference sound, the bias corrector 410 may include a difference sound corrector 411 configured to discern and correct a difference sound from the reference sound. The difference sound corrector 411 may be a program module in the form of, for example, routines, subroutines, programs, objects, components, instructions, data structures, and the like for performing specific tasks or executing specific abstract data types as will be described below in accordance with the present disclosure. Here, the reference sound refers to a sound determined to match a corresponding sound in a 12-tone chromatic scale and may be represented using a frequency converted therefrom, and the difference sound refers to a difference (bias) value between a sound input by a user and measured and the reference sound. For example, in a case in which the reference sound is a pitch “A” of the fourth octave, a frequency of the reference sound is 440 hertz (Hz). In a case in which a frequency of the sound input by the user is 450 Hz, the difference sound may be calculated at 10 Hz. As described above, a difference (bias) value that wholly or partially appears due to a relative sense of pitch or a unique tendency of the user may be measured based on the 12-tone chromatic scale.

The difference sound corrector 411 may determine whether to correct and a level of the correction by measuring a degree and a direction of a difference in comparison to the reference sound, and perform a correction appropriately. Further, after the correction, whether to perform an additional correction may be determined by verifying whether a tonality and a chord are appropriate. The difference sound corrector 411 may be configured to extract bias information, that is, difference sound information that is verified previously with respect to the same user as described above, and correct the difference sound more accurately based on the extracted bias information.

The key extractor 320 may be configured to extract information related to a key from the humming melody. The key extractor 320 may extract a suitable tonality and a key signature by analyzing the input melody. For example, through an analysis of the whole melody, a corresponding major key or a corresponding minor key and a related scale may be extracted and selected. For example, in a case of a major key, a suitable one may be selected from C major, G major, D major, and A major and a related scale may be extracted. A harmonic chord may differ for each tonality. Thus, the analysis of the information related to the key may also be used to generate a chord.

A key signature based corrector 420 of the accompaniment corrector 400 may correct a melody line to be suitable for the key signature based on the key signature extracted from the key extractor 320. For example, the melody line may be corrected to be suitable for a scale corresponding to the key signature or to be suitable for a key signature designated by the user.

The chord generator 330 may be configured to generate chord information for each measure based on the input humming melody. The chord generator 330 may generate the chord based on constituent sounds of the corresponding measure and a chord composition of a previous measure. Thus, a chord suitable for a current measure may be extracted and generated based on a chord progression. For example, the chord generator 330 may extract and generate a suitable chord based on a chord progression in a single previous measure, two previous measures, three previous measures, four previous measures, or more previous measures.

A chord information based corrector 430 of the accompaniment corrector 400 may correct the melody using a composition of sounds suitable for the chord based on the chord extracted and generated by the chord generator 330.

The tempo (BPM) measurer 340 may measure a tempo of music based on the input humming melody. Here, the tempo (BPM) measurer 340 may measure a tempo value for each section by setting a plurality of partial sections.

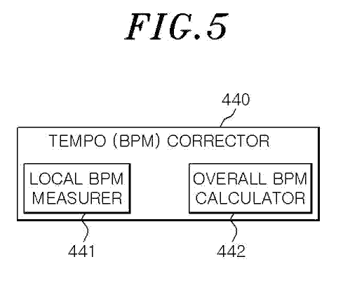

A tempo (BPM) corrector 440 may correct and calculate a tempo in a whole section or a portion of the section based on the tempo values measured in the plurality of partial sections. Through the tempo (BPM) correction as described above, a context may be considered by measuring section tempos in a plurality of predetermined section (window) a number of times, rather than uniformly measuring a tempo in the whole section, whereby the tempo may be corrected wholly or locally. A tempo (BPM) correcting operation will be described further with reference to FIG. 5.

The accompaniment generator 300 may further include the melody similarity determiner 350 configured to determine similarities between the melody extracted by the melody extractor 310 and a plurality of melodies stored in a melody database (DB) (not shown). The melody DB may store various existing melodies, and a melody search and access may be enabled through the melody DB to determine a melody similarity and likeness.

The melody similarity determiner 350 may determine, through a comparison to the plurality of melodies stored in the melody DB, that the melody extracted by the melody extractor 310 is similar to a predetermined melody if the extracted melody is similar to the predetermined melody in at least a portion, for example, at least a predetermined criterion such as a single measure, two measures, or four or more measures.

For example, in determining a similarity between melodies, a relative similarity and likeness may be calculated by comparing a first discrete music sequence corresponding to a music sequence received from the melody DB to a second successive music sequence corresponding to a music signal received from the user, that is, a user music signal that successively changes over time, when comparing the music signal received from the user and the music sequence received from the melody DB.

In a case in which the melody similarity determiner 350 determines that the user melody extracted from the humming of the user is similar to a predetermined melody stored in the melody DB, a melody similarity based corrector 450 of the accompaniment corrector 400 may correct at least a portion of the user melody based on a similarity between the user melody and the predetermined melody in the melody DB. For example, in the melody correction, predetermined sounds may be corrected to be suitable for a predetermined melody, or at least one measure may be replaced with a corresponding measure of the predetermined melody. In a case of being replaced with an existing melody, eight or fewer measures may be corrected to avoid music plagiarism. The determination of the similarity between the melodies and the correction based on the similarity may be automatically performed through melody learning through machine learning.

Further, the melody similarity based corrector 450 may correct the melody by applying at least one of various attributes related to music, for example, a genre, an era, a country, a region, and a music style for each musician, or by applying a music style of the user or a predetermined user. For example, the music style may be determined based on a user input received through the input receiver 210, or a music style suitable for the corresponding melody may be automatically determined, or a list of recommended music styles may be provided to the user.

The score display 360 may generate and display a score based on the accompaniment and the melody generated by being corrected finally through the correcting operation of the accompaniment corrector 400. For example, scores of various forms may be generated and displayed based on various musical genres or user settings.

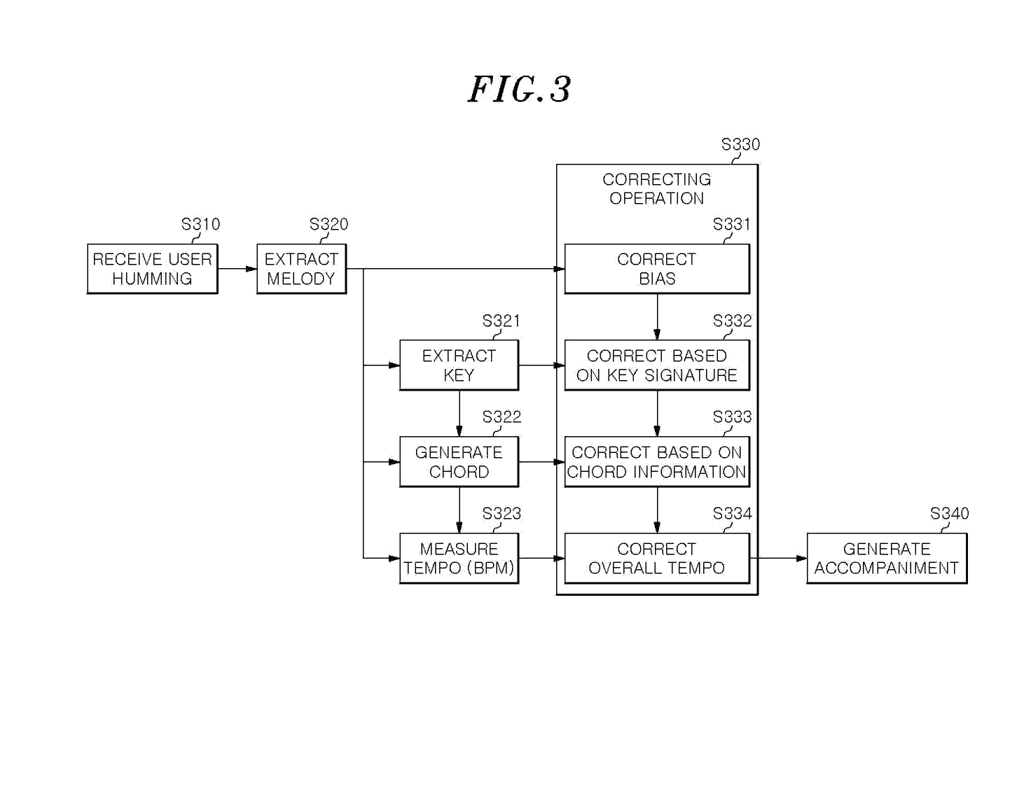

FIG. 3 is a flowchart illustrating a method of providing an accompaniment based on a humming melody of a user according to an example embodiment.

In operation S310, a humming voice signal of a user may be received. In operation S320, a melody may be extracted from the received humming melody by measuring a pitch value in real time.

In operation S321, a key may be extracted from the whole extracted melody or each section of the extracted melody. In operation S322, a chord may be generated. In operation S323, a tempo (BPM) may be measured. An accompaniment and a score may be generated based on information related to the key, the chord, and the tempo (BPM) analyzed and extracted as described above. In operation S330, a correcting operation may be performed to generate an accompaniment and a score that are suitable for an intent of the user and most natural.

In operation S331, a bias correction may be performed by wholly or partially correcting a shaking of a melody line or a melody biased in one direction in the extracted melody, or verifying whether a bias from a reference sound occurs due to a relative sense of pitch of the user and correcting a pitch by a difference sound from the reference sound.

In operation S332, by extracting a key signature based on the key extracted through the melody analysis, the melody or the melody line may be corrected based on the key signature so as to be suitable for a corresponding major key or a minor key, and a corresponding scale.

In operation S333, after extracting and generating the chord through the melody analysis, the melody or the melody line may be corrected using a composition of sounds suitable for the chord.

In operation S334, a tempo in a whole section may be corrected and calculated based on tempo values measured in a plurality of partial sections. Suitable notes may be generated based on an overall tempo calculated through the correction as described above.

In operation S340, a accompaniment may be generated finally through the above correcting operations. Further, a score may be generated based on the accompaniment generated as described above and displayed on a user display, and a play of music may be output in response to a selection of the user.

A portion of the operations in the flowchart may be omitted, performed in a different order, or performed iteratively as necessary.

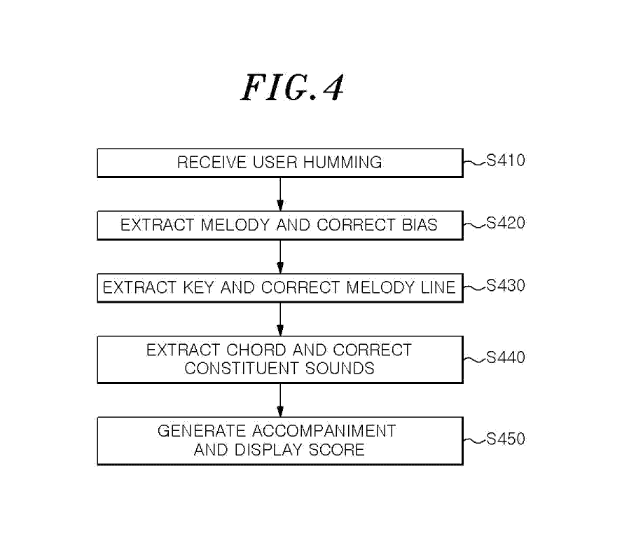

FIG. 4 is a flowchart illustrating a method of providing an accompaniment based on a humming melody of a user according to another example embodiment.

Referring to FIG. 4, in operation S410, a humming voice signal of a user may be received. In operation S420, a melody may be extracted from the received humming melody by measuring a pith value in real time, a difference sound from a reference sound may be discerned in the extracted melody, and a bias correction may be performed based on the difference sound.

In operation S430, a key may be extracted from the extracted melody, and a melody line may be corrected based on the extracted key and a key signature so as to be suitable for a corresponding major key or a minor key and a corresponding scale.

In operation S440, after extracting and generating a chord through a melody analysis, constituent sounds may be corrected using a composition of sounds suitable for the chord.

In operation S450, an accompaniment may be generated finally by performing a correcting operation through a melody bias, the key, and the chord extracted and generated as described above and a score may be displayed.

A portion of the operations in the flowchart may be omitted, performed in a different order, or performed iteratively as necessary.

FIG. 5 is a block diagram illustrating a configuration of a tempo (BPM) corrector of an apparatus for providing an accompaniment based on a humming melody of a user according to an example embodiment.

Referring to FIG. 5, a tempo (BPM) corrector 440 may include a local tempo (BPM) measurer 441 and a representative tempo (BPM) calculator 442. The local tempo (BPM) measurer 441 and the representative tempo (BPM) calculator 442 may be program modules in the form of, for example, routines, subroutines, programs, objects, components, instructions, data structures, and the like for performing specific tasks or executing specific abstract data types as will be described below in accordance with the present disclosure.

The local tempo (BPM) measurer 441 may be configured to measure section tempos (BPMs) in a plurality of predetermined window sections. At least a portion of the plurality of predetermined window sections may overlap at least one of an immediately previous window section and an immediately subsequent window section. Here, a first section may overlap only a section subsequent thereto since there is no section previous thereto, and a last section may overlap only a section previous thereto since there is no section subsequent thereto. At least a portion of window sections positioned therebetween may each overlap a window section previous thereto and a window section subsequent thereto. Thus, a local tempo (BPM) may be measured in each window section.

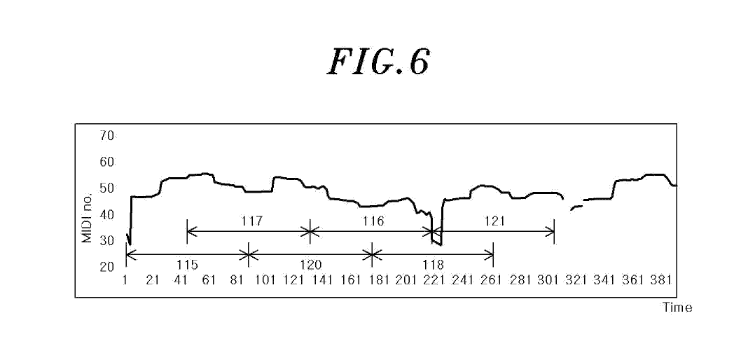

In further detail, referring to FIG. 6, a tempo (BPM) correction may be performed through local tempo (BPM) measurement in a plurality of successive windows con figured such that a half of each section overlaps a window section subsequent thereto.

A local tempo (BPM) in a first section is measured at 115, a local tempo (BPM) in a second section is measured at 117, a local tempo (BPM) in a third section is measured at 120, a local tempo (BPM) in a fourth section is measured at 116, a local tempo (BPM) in a fifth section is measured at 118, and a local tempo (BPM) in a sixth section is measured at 121. The local tempos (BPMs) in the respective window sections continuously change to 115, 117, 120, 116, 118, and 121. As described above, a representative tempo value in the whole section or a portion of the section may be calculated through an algorithm that measures a tempo (BPM) even in view of a context by iteratively measuring section tempo (BPM) values in the plurality of local window sections, rather than measuring a tempo in the whole section one time.

As shown in the example of FIG. 6, when a pattern in which a humming tempo of a user is slightly fast in a portion of the section and slightly slows down in another portion of the section is repeated due to the unstable overall humming tempo of the user, a tempo correction may be performed by determining the representative tempo (BPM) value over the whole section. Further, when the humming tempo of the user gradually speeds up or gradually slows down, the tempo correction may be performed by determining the representative tempo (BPM) value in view of a flow of the tempo over the whole section. Further, when the humming tempo of the user is unstable and changes greatly in a portion of the section, a tempo of the corresponding section may be corrected using a representative tempo value in the whole section or a relatively stable previous or subsequent section.

Referring to FIG. 5 again, the representative tempo (BPM) calculator 442 may be configured to calculate a representative tempo (BPM) in the whole section or a portion of the section based on the plurality of section tempo (BPM) or local tempo (BPM) values measured by the local BPM measurer 441.

For example, the tempo (BPM) corrector 440 may calculate, as the representative tempo (BPM) value, a mean value of the tempo (BPM) values in the plurality of predetermined window sections measured by the local tempo (BPM) measurer 441. By calculating a mean value of the six local tempos (BPMs) measured in the example of FIG. 6, the overall or representative tempo (BPM) value may be calculated and determined at 118 BPM.

In another example, by calculating a median value or a mode value rather the mean value, the median value or the mode value may be determined to be the representative tempo (BPM) value.

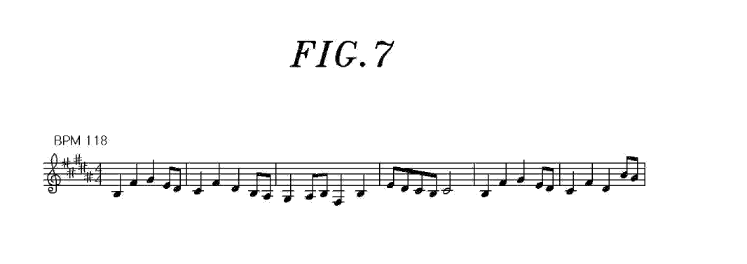

FIG. 7 illustrates an example of a score with an indication of an overall tempo (BPM) according to an example embodiment.

As calculated in the above example, the overall tempo (BPM) value of 118 may be indicated on a score, a humming melody may be converted into notes having appropriate durations based on the representative tempo value corrected and calculated as described above and the notes may be represented on the score.

By the configuration described in the example embodiments, a method and apparatus for providing an accompaniment based on a humming melody of a user that additionally has a melody correcting function in view of a unique characteristic of each user, a natural melody line, and a chord based on a melody input through a user voice or humming with inaccurate pitches unlike a musical instrument performance may be provided.

Further, by the configuration described in the example embodiments, a method and apparatus for providing an accompaniment based on a humming melody of a user that may calculate a representative corrected tempo (BPM) in view of an overall flow when a tempo is not uniform in a whole section in a case in which a melody is input through a user voice or humming may be provided.

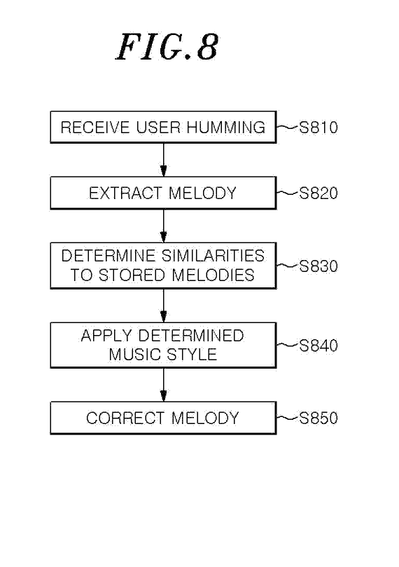

FIG. 8 is a flowchart illustrating an operation of correcting a melody based on similarities to pre-stored melodies according to an example embodiment.

Referring to FIG. 8, in operation S810, a humming voice signal of a user may be received. In operation S820, a melody may be extracted from the received humming melody by measuring a pitch value in real time. In this example, a difference sound from a reference sound may be discerned in the extracted melody, and a bias correction may be performed based on the difference sound.

In operation S830, the melody similarity determiner 350 may determine whether the extracted user melody is similar to an existing melody through a comparison of the extracted user melody to a plurality of melodies stored in a melody DB. Whether the extracted user melody is similar to an existing melody may be determined by verifying whether the user melody is similar to the existing melody in at least a portion.

In response to determination that both the melodies are similar, the melody may be corrected. In this example, in operation S840, the melody correction may be performed by applying a genre of music, an era, a country, a region, and a music style for each musician or by applying a style of the user or a predetermined user.

In operation S850, based on the determined similarity to the existing melody, predetermined sounds of the user melody may be corrected to be suitable for a predetermined melody, or at least one measure may be replaced with a measure corresponding to the predetermined melody.

Although the method and apparatus for providing an accompaniment based on a humming melody have been described in detail above through a number of example embodiments, the present disclosure is not limited thereto and should be construed as having the widest range according to the basic spirit disclosed herein. Those skilled in the art may implement a pattern of a form not stated above by combing or replacing the disclosed example embodiments, which should also be construed as within the scope of the present disclosure. Further, it will be apparent to those skilled in the art that various modifications and variation can be easily made to these example embodiments without departing from the spirit or scope of the claims.

What is claimed is:

1. An apparatus for providing an accompaniment based on a humming melody, the apparatus comprising:
a user input receiver configured to receive a humming melody of a user;
a melody extractor configured to measure a pitch from the received humming melody;
a key extractor configured to extract a key from the humming melody; and
a chord generator configured to generate a chord for each measure related to the accompaniment based on the humming melody.

2. The apparatus of claim 1, further comprising:
a bias corrector configured to correct the pitch of the received humming melody.

3. The apparatus of claim 1, further comprising:
a tempo (beat per minute (BPM)) corrector configured to correct and calculate a tempo in a whole section or a portion of the section based on tempo values measured in a plurality of partial sections.

4. The apparatus of claim 3, wherein the tempo (BPM) corrector comprises a local BPM measurer configured to measure BPMs in a plurality of predetermined window sections and a representative tempo (BPM) calculator configured to calculate an overall or section tempo (BPM) based on a plurality of local tempo (BPM) values measured by the local tempo measurer, and at least a portion of the plurality of predetermined window sections overlap at least one of an immediately previous window section and an immediately subsequent window section.

5. The apparatus of claim 4, wherein the tempo (BPM) corrector is configured to calculate, as a representative tempo (BPM) value, one of a mean value, a median value, and a mode value of tempo (BPM) values in the plurality of predetermined window sections.

6. The apparatus of claim 2, wherein the bias corrector comprises a difference sound corrector configured to correct a difference sound from a reference sound.

7. The apparatus of claim 6, wherein the difference sound corrector is configured to correct the difference sound based on difference sound information of the user that is verified previously.

8. The apparatus of claim 6, wherein the difference sound corrector is configured to correct the difference sound by measuring a degree and a direction of a difference in comparison to the reference sound.

9. The apparatus of claim 1, wherein the chord generator is configured to generate the chord based on constituent sounds of the corresponding measure and a chord composition of a previous measure.

10. The apparatus of claim 1, further comprising:
an accompaniment corrector configured to correct a melody based on at least one of information related to the key extracted by the key extractor and information related to the chord generated by the chord generator.

11. The apparatus of claim 1, further comprising:
a melody similarity determiner configured to determine similarities between a melody extracted by the melody extractor and a plurality of melodies stored in a melody database (DB); and
a melody similarity based corrector configured to correct at least a portion of the extracted melody based on a similarity between the extracted melody and a predetermined melody among the plurality of melodies stored in the melody DB in response to determination that the extracted melody is similar to the predetermined melody.

12. The apparatus of claim 11, wherein the melody similarity based corrector is configured to correct the melody by applying at least one of a genre, an era, a country, a region, and a music style for each musician.

13. A method of providing an accompaniment based on a humming melody, the method comprising:
a user input operation of receiving a humming melody of a user;
a melody extracting operation of measuring a pitch from the received humming melody;
a key extracting operation of extracting a key from the humming melody;
a chord generating operation of generating a chord for each measure related to the accompaniment based on the humming melody; and
generating the accompaniment based on at least one of the extracted key and the generated chord.

14. The method of claim 13, further comprising:
a bias correcting operation of correcting the pitch of the received humming melody.

15. The method of claim 13, further comprising:
a tempo (beat per minute (BPM)) correcting operation of correcting and calculating a tempo in a whole section or a portion of the section based on tempo values measured in a plurality of partial sections.

16. The method of claim 15, wherein the tempo (BPM) correcting operation comprises a local BPM measuring operation of measuring BPMs in a plurality of predetermined window sections and a representative tempo (BPM) calculating operation of calculating a representative tempo (BPM) based on a plurality of local tempo (BPM) values obtained in the local BPM measuring operation, and at least a portion of the plurality of predetermined window sections overlap at least one of an immediately previous window section and an immediately subsequent window section.

17. The method of claim 16, wherein the tempo (BPM) correcting operation calculates, as a representative tempo (BPM) value, one of a mean value, a median value, and a mode value of tempo (BPM) values in the plurality of predetermined window sections.

18. The method of claim 13, wherein the chord generating operation generates the chord based on constituent sounds of the corresponding measure and a chord composition of a previous measure.

19. The method of claim 13, further comprising:
an operation of correcting a melody based on at least one of information related to the key extracted in the key extracting operation and information related to the chord generated in the chord generating operation.

20. The method of claim 13, further comprising:
a melody similarity determining operation of determining similarities between a melody extracted in the melody extracting operation and a plurality of melodies stored in a melody database (DB); and
a melody similarity based correcting operation of correcting at least a portion of the extracted melody based on a similarity between the extracted melody and a predetermined melody among the plurality of melodies stored in the melody DB in response to determination that the extracted melody is similar to the predetermined melody.
